(19) United States
(12) Patent Application Publication
(10) Pub. No.: US 2007/0177048 A1
(43) Pub. Date: Aug. 2, 2007

(54) Long exposure images using electronic or rolling shutter

(76) Inventors: Phil Van Dyke, Surrey (CA); Eric Jeffrey, Richmond (CA)

Correspondence Address: EPSON RESEARCH AND DEVELOPMENT INC;INTELLECTUAL PROPERTY DEPT, 2580 ORCHARD PARKWAY, SUITE 225, SAN JOSE, CA, 95131, US

(21) Appl. No.: 11/344,256

(22) Filed: Jan. 31, 2006

(51) Int. Cl. G03B 7/00; H04N 5/235

(52) U.S. Cl. 348/362

(57) ABSTRACT

A method for generating a long exposure image is described. The method includes receiving image data for a plurality of images and adding the image data to a frame buffer. For each of the images, image data corresponding to a long exposure region is added to the frame buffer by adding a color value for each pixel from the image data to a corresponding color value of a corresponding pixel stored in the frame buffer, and storing the sum in the frame buffer. A device for generating long exposure images is also described.

### BACKGROUND

The typical image sensor in digital cameras includes a two-dimensional array of light sensors, each corresponding to one pixel of an image. Each light sensor develops an electrical charge in response to light. The brighter the light and the longer the exposure, the more charge is built up. Image data is generated by digitizing and reading out the charges of all the light sensors in the image array. After generating the image data, the sensors are reset by passing the built-up electrical charges to ground, which is referred to as resetting the sensors.

Typical exposure times for film-based and digital cameras having mechanical shutters for still images of well-lit scenes can extend from 1/250th of a second to 1/60th of a second. However, there are many instances where a longer exposure time is needed to highlight movement, or to capture a particular scene or event. An exposure time of one-half second can emphasize the speed of an object in relation to its surroundings. If a scene has very low lighting conditions, an exposure time on the order of seconds to minutes may be required to make objects in the scene visible. Exposures of a half hour or longer are frequently used in nighttime photography, for example, to show star trails.

In the case of film-based cameras as well as digital cameras with mechanical shutters, an image having a long exposure is created by simply opening a mechanical shutter for an extended period of time, as selected by the user or automatically in response to lighting conditions. In digital cameras, the charge present in each light sensor is digitized after the exposure period, i.e., when the shutter closes. However, many lower-cost cameras and video cameras do not have a mechanical shutter and instead rely on a rolling shutter, which is an implementation of an electronic shutter.

In an electronic shutter, releasing a light sensor from reset, thereby allowing the corresponding electrical charge to build up, is equivalent to opening a mechanical shutter for that sensor. In a rolling shutter, only one or several lines are released from a reset condition at a time. While one or more lines are “exposed” by releasing them from reset, image data is read from a previously exposed image line. After the last line of the image is read, the process is repeated to capture a new image frame. By repeating this process, a video stream can be generated.

Unfortunately, since the electronic shutter resets the image line after each exposure period, it has heretofore not been possible to generate long-exposure images with digital cameras having electronic shutters. In the on-going quest to provide more features in inexpensive imaging devices, it would be desirable to allow a user to generate a long exposure image without having to include a mechanical shutter. Furthermore, it would be desirable to enhance the use of the electronic shutter by providing imaging features not possible with a mechanical shutter, such as imaging some regions of an image with a long exposure time, and other regions with a short exposure time.

### SUMMARY

Broadly speaking, the present invention fills these needs by providing a method and device for long exposure images for devices having an electronic shutter.

It should be appreciated that the present invention can be implemented in numerous ways, including as a process, an apparatus, a system, a device, or a method. Several inventive embodiments of the present invention are described below.

In one embodiment, a method for generating a long exposure image is provided. The method includes receiving image data for a plurality of images and adding the image data to a frame buffer. For each of the images, image data corresponding to a long exposure region is added to the frame buffer by adding a color value for each pixel from the image data to a corresponding color value of a corresponding pixel stored in the frame buffer, and storing the sum in the frame buffer.

In another embodiment, a device for generating a long exposure image is provided. The device includes a camera interface for receiving image data for a plurality of images, a frame buffer for temporarily storing data corresponding to an image, a plurality of registers for storing operational parameters, and long exposure logic in communication with the camera interface, the frame buffer, and the registers. The operational parameters stored in the registers include a definition for a long exposure region and an exposure period for the long exposure region. The long exposure logic is configured to add image data corresponding to the long exposure region to the frame buffer for each of a plurality of images making up the exposure period. The image data is added by adding a color value for each pixel of the long exposure region from the image data to a corresponding color value of a corresponding pixel stored in the frame buffer, and storing the sum in the frame buffer.

In yet another embodiment, a method for combining a plurality of frames of images to a single long exposure image is provided. The method includes receiving image data corresponding to a pixel of a current one of the frames. The pixel is identified as either corresponding to an active long exposure region or not, the active long exposure region being a long exposure region for which data from the current frame is to be stored. The image data is added to stored image data when the pixel corresponds to the active long exposure region. Data is added by arithmetically adding a luminance of the current image data to the luminance of the stored image data and writing the sum to the storage location. The image data is written to a storage location when the pixel does not correspond to any active long exposure region and the current frame is a short exposure frame. The image data is discarded when the pixel does not correspond to any active long exposure region and the current frame is not the short exposure frame.

The advantages of the present invention will become apparent from the following detailed description, taken in conjunction with the accompanying drawings, illustrating by way of example the principles of the invention.

### BRIEF DESCRIPTION OF THE DRAWINGS

The present invention will be readily understood by the following detailed description in conjunction with the accompanying drawings, wherein like reference numerals designate like structural elements.

FIG. 1 is an illustration showing a high-level architecture of imaging device.

FIG. 2 is a representation of a long-exposure image having star trails in long exposure region.

FIG. 3 shows an exemplary embodiment of graphics controller.

FIG. 4 is a schematic diagram showing certain details of graphics controller.

FIG. 5 shows a flowchart depicting long exposure image functionality for an imaging device having an electronic shutter.

FIG. 6 shows a flowchart that further identifies an exemplary mechanism for performing the functions identified in FIG. 5.

FIG. 7 shows a flowchart depicting an exemplary procedure for determining whether the current image data is within an active long exposure region.

### DETAILED DESCRIPTION

In the following description, numerous specific details are set forth in order to provide a thorough understanding of the present invention. However, it will be apparent to those skilled in the art that the present invention may be practiced without some of these specific details. In other instances, well known process operations and implementation details have not been described in detail in order to avoid unnecessarily obscuring the invention.

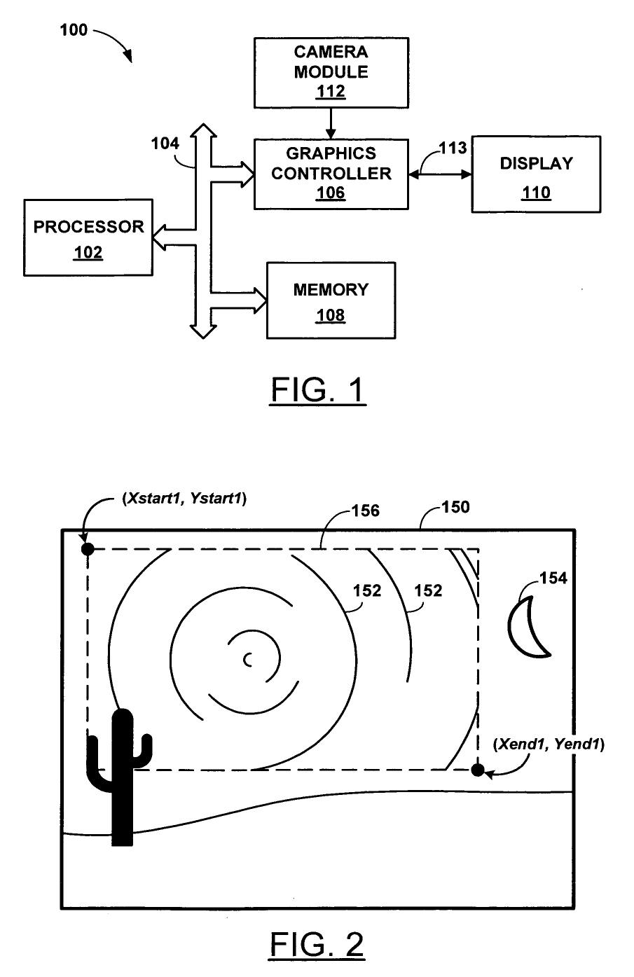

FIG. 1 is an illustration showing a high-level architecture of imaging device 100. Imaging device 100 may be a digital camera, digital video recorder, or some electronic device incorporating image capture or video recorder functionality, such as, for example, a personal digital assistant (PDA), cell phone, or other communications or electronic device. Imaging device 100 includes a processor 102 in communication with a graphics controller 106 and memory 108 over a bus 104. The graphics controller 106 provides an interface between processor 102, display 110, and camera module 112.

The timing control signals and data lines between graphics controller 106 and display 110 are shown generally as line 113. These may in fact be several separate address, data and control lines but are shown generally as line 113, which may be referred to as a bus. It should be recognized that such data pathways may represented throughout the figures as a single line. Processor 102 performs digital processing operations and communicates with graphics controller 106 and memory 108 over bus 104.

In addition to the components mentioned above and illustrated in FIG. 1, those skilled in the art will recognize that there may be many other components incorporated into device 100, consistent with a particular application. For example, if device 100 is a cell phone, then wireless network interface, digital-to-analog and analog-to-digital converters, amplifiers, keypad input, and so forth will be provided. Likewise, if device 100 is a PDA, various hardware consistent with providing a PDA will be included in device 100. It will therefore be understood that FIG. 1 is not intended to be limiting, but rather to present those components related to certain novel aspects of the device.

Processor 102 performs digital processing operations and communicates with graphics controller 106. In one embodiment, processor 102 comprises an integrated circuit capable of executing instructions retrieved from memory 108. These instructions provide device 100 with functionality when executed on processor 102. Processor 102 may also be a digital signal processor (DSP) or other computing device.

Memory 108 may be internal or external random-access memory or non-volatile memory. Memory 108 may be non-removable memory such as flash memory or other EEPROM, or magnetic media. Alternatively, memory 108 may take the form of a removable memory card such as ones widely available and sold under such trademarks as “SD Card,” “Compact Flash,” and “Memory Stick.” Memory 108 may also be any other type of machine-readable removable or non-removable media. Memory 108, or a portion thereof, may be remote from device 100. For example, memory 108 may be connected to device 100 via a communications port (not shown), where a BLUETOOTH® interface or an IEEE 802.11 interface, commonly referred to as “Wi-Fi,” is included. Such an interface may connect imaging device 100 with a host (not shown) for transmitting data to and from the host. If device 100 is a communications device such as a cell phone, it may include a wireless communications link to a carrier, which may then store data in hard drives as a service to customers, or transmit data to another cell phone or email address. Memory 108 may be a combination of memories. For example, it may include both a removable memory card for storing image data, and a non-removable memory for storing data and software executed by processor 102.

Display 110 can be any form of display capable of displaying a digital image. In one embodiment, display 110 comprises a liquid crystal display (LCD). However, other types of displays are available or may become available that are capable of displaying an image that may be used in conjunction with device 100. Although camera module 112 and display 110 are presented as being part of imaging device 100, it is possible that one or both of camera module 112 and display 110 are external to or even remote from each other and/or graphics controller 106. For example, if imaging device 100 can be used as a security camera or baby monitor, it may be desirable to provide a display 110 that is separable from or remote to the camera module 112 to provide monitoring capability at a remote location. In another embodiment, e.g., for a compact camera, display 110 is not provided. In this case, the photographer may rely on an optical view finder (not shown) or other means for aligning the image sensor with the intended subject.

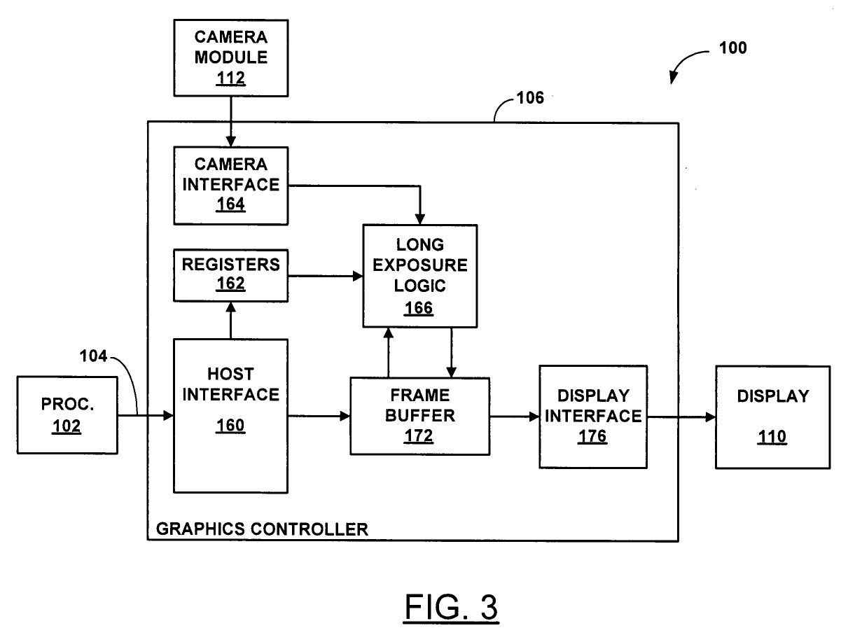

Camera module 112 includes an imaging sensor that utilizes an electronic shutter and periodically sends frames of image data to graphics controller 106 in accordance with various timing signals such as a pixel clock, a horizontal sync signal, and a vertical sync signal, as generally known and understood in the art. The image data may be in any of a variety of digital formats, such as a raw format, a Joint Photographic Experts Group (JPEG) format, Moving Picture Experts Group (MPEG) format, an RGB format, and a luminance/chrominance format such as YUV. In a raw format, data is read from the digital sensor as it is generated. In a JPEG or MPEG formats, the image data is compressed according to various algorithms known in the art. In an RGB format, the image data is represented by three planes of data including luminance values for red, green, and blue light for each pixel. In the luminance/chrominance format, three planes of data provide one luminance value for each pixel, identifying a brightness, and two chrominance values for each pixel, identifying a color. Logic for converting image data from one format to another (not shown) may be provided between camera module 112 and graphics controller 106, or may be incorporated into either. It should also be noted that camera module may be designed to generate “black and white,” or gray-scale, images only in which case, the data may be formatted to provide a single luminance channel. As described herein, image data is referred to as “luminance image data” when it contains pixel values corresponding to brightness of the respective pixel. RGB and grayscale image data is luminance image data. The Y channel of YUV image data is also a luminance value. Luminance values from successive images are added together to artificially increase the exposure length, as described in more detail below with reference to FIGS. 3-7.

FIG. 2 is a representation of a long-exposure image 150 having star trails 152 in long exposure region 156. In one embodiment, long exposure region 156 is the rectangular area defined by a pair of coordinates identifying opposite corners of the region. The coordinate pair may, for example, include an upper left coordinate (Xstart1, Ystart1) and a lower right coordinate (Xend1, Yend1). In other embodiments, multiple long exposure regions can be defined with additional coordinate pairs, e.g., (Xstart2, Ystart2)-(Xend2, Yend2) (not shown). In an actual long-exposure night-time image, star trails 152 will appear as white streaks against a dark, nighttime sky. Each star trail 152 is generated by the rotation of the Earth in relation to the stars. Over an extended exposure, each star traces out a star trail due to this movement. Outside of long exposure region 156, moon 154 is visible.

FIG. 3 shows an exemplary embodiment of graphics controller 106. Graphics controller 106 is an electronic device including logic that may, for example, be implemented in an application-specific integrated circuit (ASIC), a field programmable gate array (FPGA), or otherwise implemented in hardware. Therefore, graphics controller 106 comprises logic formed from logic gates, and may not require software instructions to operate. It is also possible to implement logic for graphics controller 106, or certain functions of graphics controller 106, in software for execution on processor 102, or a secondary graphics processor (not shown).

Processor 102 is in communication with host interface 160, which receives data and address information from processor 102 and passes the information to the appropriate locations in graphics controller 106. In one embodiment, host interface 160 is in electronic communication with registers 162 and frame buffer 172. Registers 162 may therefore be programmed by processor 102 to store various values to control the operation of graphics controller 106. As will be understood by those skilled in the art, registers 162 may be distributed throughout graphics controller, or may be collected in one or more register blocks.

Frame buffer 172 temporarily stores image data describing an image for display on display 110. Image data can be written to frame buffer 172 from processor 102, e.g., to display a message, or data can be written from camera interface 164 for displaying images generated by camera module 112. In one embodiment, frame buffer 172 has a corresponding memory location for each pixel of image data from camera interface 164. Display interface 176 retrieves image data during each frame refresh from frame buffer 172 and passes the data to display 110 in the generally known manner.

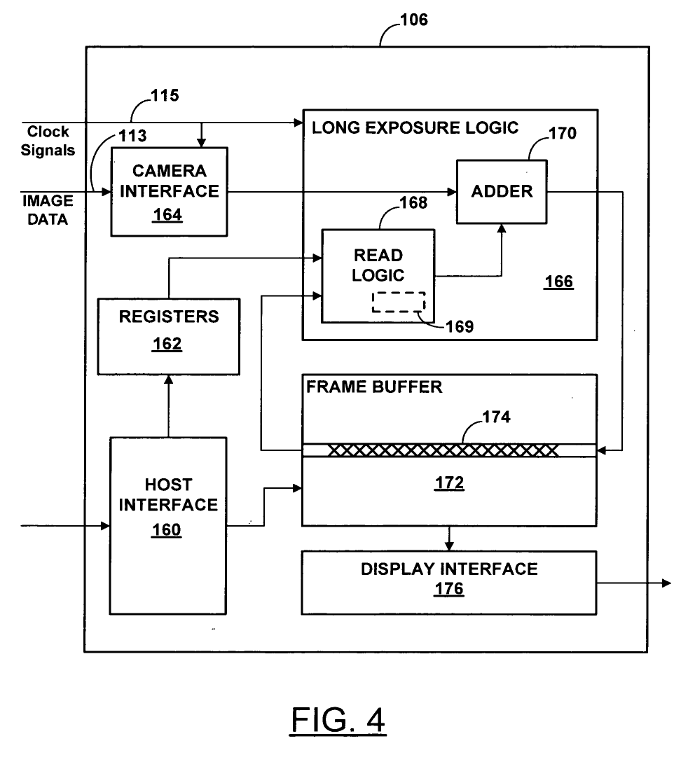

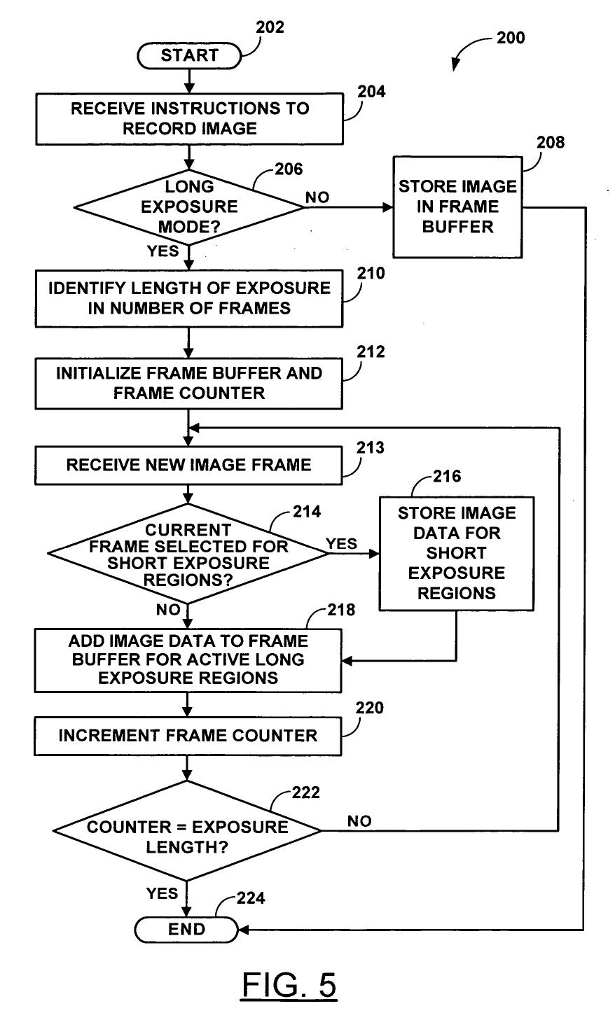

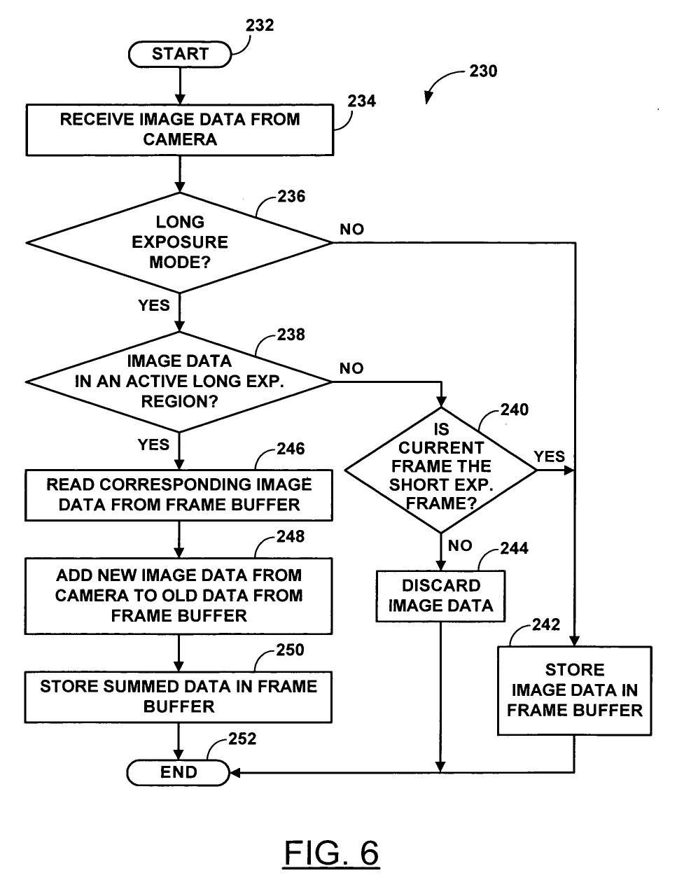

Graphics controller 106 also includes long exposure logic 166 interposed between camera interface 164 and frame buffer 172. Long exposure logic 166 provides long exposure functionality to graphics controller 106. In particular, luminance image data received from camera interface 164 is added to existing data read from frame buffer 172 and stored back into frame buffer 172. Operation of long exposure logic 166 is described in more detail below with reference to FIGS. 4 and 5.

FIG. 4 is a schematic diagram showing certain details of graphics controller 106. Long exposure logic 166 includes read logic 168 and an adder 170. Clock signals 115 are received by long exposure logic 166 allowing long exposure logic 166 to track the coordinates of the current pixel being received from camera interface 164. In one embodiment, read logic 168 includes internal counters 169 to track the coordinates of the current pixel and the frame number for the long exposure image. In addition, read logic 168 inputs register values from registers 162 which identify one or more long exposure regions, and a number of frames corresponding to each long exposure region.

Table 1 represents exemplary register values held by registers 162 which read logic 162 may receive. Image Width and Image Height provide long exposure logic 166 with the overall dimensions of the image received from camera interface 164, in pixels. It is possible that the image area is less than the total display area of display 110 (FIG. 3). For example, image data from camera interface may be presented in a portion of display 110. In one embodiment, there may be multiple long exposure regions of the display. In this embodiment, each long exposure region is rectangular and is defined by upper left and lower right coordinates as described above with reference to FIG. 2. Additional register values include a frames value for each long exposure region, e.g., frames1, frames2, etc., and, a short exposure frame value. Frames1 indicates the length of time of the exposure expressed as a number of frames for long exposure region 1. Thus, if image refresh occurs at fifteen frames per second, a frames1 value of 30 will define a 2-second exposure time for the first long exposure region. The value short exposure frame indicates the frame number that provides the data outside the long exposure regions. This could be the first frame or the last frame in the sequence, or any frame in between. In a different embodiment, a one bit flag is used to identify whether the first or last frame data is saved.

TABLE 1

| Value Name | Description of Value |
|---|---|
| Image Width | Display width (x direction) in pixels |
| Image Height | Display height (y direction) in pixels |
| Xstart1 | Left edge of first long exposure region |
| Ystart1 | Top edge of first long exposure region |
| Xend1 | Right edge of first long exposure region |
| Yend1 | Bottom edge of first long exposure region |
| frames1 | Number of frames for first long exposure region |
| short exposure | Frame number to obtain image data of short exposure |
| frame | regions |
| Xstart2 | Left edge of second long exposure region |
| Ystart2 | Top edge of second long exposure region |
| Xend2 | Right edge of second long exposure region |
| Yend2 | Bottom edge of second long exposure region |
| frames2 | Number of frames for second long exposure region |
| Xstart3 | Left edge of third long exposure region |
| . . . | |

In the case where there are multiple long exposure regions, each long exposure region may have a different exposure duration. This can provide, for example, for a smooth transition from a long exposure region to the short exposure region. Alternatively, or in addition thereto, multiple exposure regions can be defined that are of a similar duration, but define an overall irregular shape. This can, for example, provide a long exposure of the night sky to highlight the stars while maintaining a shorter exposure of bright objects such as a city skyline and/or the moon.

Returning to FIG. 4, read logic 168, in response to values stored in registers 162, determines whether the image data for the current pixel should be added to the stored value, stored directly, or discarded. When the current pixel is to be added to the stored value, read logic 168 accesses frame buffer 172, and reads the corresponding color value. The corresponding value is the one that has the same display coordinates as the current pixel. This value is retrieved from frame buffer and passed to adder 170, along with the color value of the current pixel. In one embodiment, the color values are represented as separate red, green, and blue intensity, at, for example, eight bits per pixel. This provides up 256 different gradations of red, green, or blue, for each pixel. In adder 170, the three values are added in parallel for each pixel. Thus, for each pixel, the new blue value is added to the stored blue value, the new red value is added to the stored red value, and the new green value is added to the stored green value. The resulting 24-bit color value (consisting of 8 bits each of red, green, and blue) is then stored back into frame buffer 172. As mentioned previously, it is also possible to use luminance/chrominance values for a color-encoding scheme such as YUV. In luminance/chrominance, one channel provides a luminance level and the remaining two channels provide chrominance. In such an embodiment, the luminance channel is added while the chrominance channels are averaged.

FIG. 5 shows a flowchart 200 depicting long exposure image functionality for an imaging device having an electronic shutter. The procedure begins as indicated by start block 202 and flows to operation 204 wherein the graphics controller receives instructions to record an image. In one embodiment, this is initiated by user interaction. For example, a user presses a shutter button, which closes a contact monitored by the processor. The processor may perform a number of operations in response to the user interaction, including, for example, measure the brightness of the scene, set exposure settings, trigger a flash, etc., or copy a currently stored image from the frame buffer to another memory location. The precise response of the processor may depend on a number of factors, including implementation details and operational mode, which may be user-selectable. After receiving the instruction to record an image, the procedure flows to operation 206.

In operation 206, it is determined whether the device is in a long exposure mode. This determination may be made by reading one or more register values. In one embodiment, one register contains a one-bit flag for indicating that a long exposure mode has been enabled. If the device is not in a long exposure mode, then the procedure flows to operation 208 wherein the current image is stored in the frame buffer. This is the normal operation for normal-length exposure images. After storing the current image in the frame buffer, the procedure ends as indicated by end block 224. If, in operation 206, it is determined that long exposure mode is enabled, then the procedure flows to operation 210.

In operation 210, the length of the exposure period is identified. In cases where there are multiple long exposure regions having different exposure periods, the longest exposure period is identified. In one embodiment, long exposure regions are sorted before loading them into the registers such that the long exposure region having the longest exposure period is listed first. After identifying the exposure length, the procedure flows to operation 212. In operation 212, the frame buffer is initialized so that each storage location contains a value representing a black pixel color. In an embodiment storing image data in RGB format, each of the red, blue, and green channels for each pixel are set to zero. In addition, a frame counter is initialized. In one embodiment, the frame counter is initialized to zero. In this embodiment, the frame counter is used to compare the current frame number to the total number of frames as described below with reference to operation 222. As would be understood by those skilled in the art, it is also possible to initialize the frame counter to the total number of frames, the frame counter being decremented with each frame refresh until it reaches zero, thereby counting down rather than up. After initializing the frame buffer and counters, the procedure flows to operation 213 wherein a new frame of image data is received. After receiving the new image data, the procedure flows to operation 214.

In operation 214, it is determined whether the current frame is selected for the short exposure region. As mentioned previously, it is possible that the one or more long exposure regions do not completely cover the image area. In this case, one of the frames of the long exposure period is selected to provide image data for the pixels outside the long exposure regions. This frame is referred to herein as the short exposure frame. In one embodiment, the short exposure frame is the first frame of the long exposure period. In another embodiment, the short exposure frame is the last frame of the long exposure period. In yet another embodiment, the short exposure frame is selectable between the first or last frame of the long exposure period. It is also possible to allow the user to select a middle frame, or a particular frame number. If the current frame is the short exposure frame, then the procedure flows to operation 216 wherein the image data for the short exposure region is stored to the frame buffer. After storing the image data for the short exposure region, the procedure flows to operation 218. If the current frame is not the short exposure frame, then the procedure flows to directly from operation 214 to operation 218.

In operation 218, image data for the active long exposure regions is added to the frame buffer. If there is more than one long exposure region, it is possible that some image data may lie within a long exposure region that is not currently active, i.e., being exposed. For example, if a first long exposure region is set to a two second exposure time, and a second long exposure region is set to a one second exposure time, then the second exposure is not actively being exposed for one second while the other region is being exposed. Image data for the second region is discarded during that period. Image data for active long exposure regions, however, is added to the frame buffer. The term, “added” is used herein to identify that, for each pixel, the data is combined with existing data. In embodiments incorporating an RGB data format, the luminance of each channel is added to the pre-existing luminance values, and the sum is written back into the frame buffer, as described above with reference to FIG. 4. After adding image data for the active long exposure regions, the procedure flows to operation 220

In operation 220, the frame counter is incremented. As mentioned above with reference to operation 212, if the frame counter is a countdown-type counter, then it is decremented. After incrementing (or decrementing) the frame counter, the procedure flows to operation 222, wherein the frame counter is compared with the exposure length. If the counter is less than the exposure length, then the procedure returns to operation 213 for reception of a new frame of image data. With a count-down type frame counter, the procedure returns to operation 213 if it is greater than zero. Otherwise, the procedure ends as indicated by the end block 224.

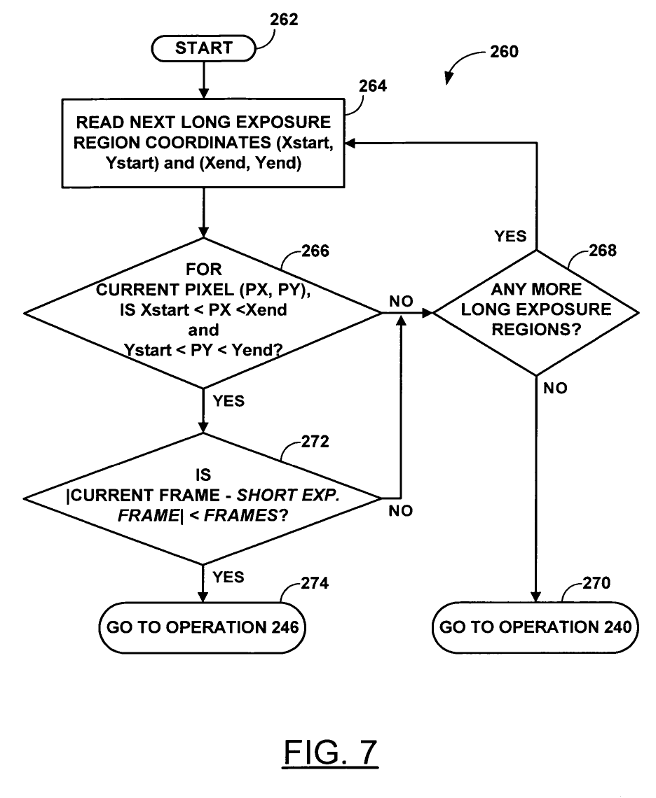

FIG. 6 shows a flowchart 230 that further identifies an exemplary mechanism for performing the functions identified in FIG. 5. In particular, flowchart 230 identifies an exemplary mechanism for determining, as it arrives, how data corresponding to each pixel is treated. The procedure begins as indicated by start block 232 and proceeds to operation 234, wherein image data is received from camera interface 164 (FIG. 4).

In one embodiment, image data is received one pixel at a time, each pixel having a 24-bit value containing three eight-bit bytes defining a color of that pixel. Thus, in an RGB format, 1 byte defines the intensity of red, one byte defines the intensity of green, and one byte defines intensity of blue for the pixel. It is possible to define the color of the pixel in other ways, as would occur to those skilled in the art. Furthermore, it is possible to receive one byte at a time or multiple pixels at a time from the camera interface, depending on design constraints, such as, for example, clock frequency, frame refresh frequency, and pin availability. While multiple pixels may be processed at a time, flowchart 230 will, for the purpose of clarity, be directed to a single pixel being considered at time. After receiving image data from the camera interface in operation 234, the procedure flows to operation 236.

In operation 236, it is determined whether the camera is in long exposure mode. If the camera is not in long exposure mode, then the procedure flows to operation 242 to store the image data in the frame buffer, overwriting any existing data in the frame buffer. The frame buffer has a defined memory location for each pixel of the image. The particular image data received in operation 234 corresponds to a particular location on the image and is therefore written to a designated location in the frame buffer. After storing the image data in the frame buffer, the procedure ends as indicated by end block 252. It should be noted that the procedure illustrated by flowchart 230 is repeated each time image data is received from the camera interface. If, in operation 236, the long exposure mode for the device is enabled, then the procedure flows to operation 238.

In operation 238, it is determined whether the image data is in a long exposure region. In one embodiment, the device only supports a single long exposure region, in which case all that is required is to determine whether the current pixel lies within the long exposure region. It is also possible that the device requires that the long exposure region corresponds to the entire image area, in which case operation 238 is not necessary and the procedure flows directly from operation 236 to operation 246. In an embodiment having multiple long exposure regions having multiple exposure times, it is determined in operation 238 whether the current image data lies within a long exposure region and if so, whether the current long exposure region is being actively exposed. Exemplary logic to make this determination is described below with reference to FIG. 7. If the current image data is not in an active long exposure region, then the procedure flows to operation 240.

In operation 240, it is determined whether the current frame is the short exposure frame. If the current frame is the short exposure frame, then the image data is written to the frame buffer and the procedure ends as indicated by end block 252. If, in operation 240, the current frame is not the short exposure frame, then the image data is discarded in operation 244, and the procedure ends as indicated by operation 252.

If, in operation 238, the current image data is in an active long exposure region, then the procedure flows to operation 246 wherein the corresponding image data is read from the frame buffer. The corresponding image data is image data in the frame buffer representing one or more pixels having the same image coordinates as the image pixels represented by the current image data. After reading the corresponding image data, the procedure flows to operation 248 wherein the new image data is added to the image data read from the frame buffer. As mentioned above, by “adding” it is meant that the luminance values are added together to produce a luminance value for the current pixel. After adding the new image data to existing image data, the procedure flows to operation 250 wherein the summed image data is written to the frame buffer. The procedure then ends as indicated by end block 252.

FIG. 7 shows a flowchart 260 depicting an exemplary procedure for determining whether the current image data is within an active long exposure region. The procedure begins as indicated by start block 262 and flows to operation 264 wherein coordinates of a next long exposure region are read from registers 162 (FIG. 4). If operation 264 has not been previously performed, then coordinates for the first long exposure region is received. In one embodiment, each long exposure region is defined by a pair of coordinates identifying opposite corners of the region. For example, one coordinate identifies the upper left corner of the long exposure region, referred to herein as (Xstart, Ystart) and one coordinate identifies the lower right corner of the long exposure region, referred to herein as (Xend, Yend). After the coordinate pair for the next long exposure region is received, the procedure flows to operation 266.

In operation 266, it is determined whether the current pixel (PX, PY) lies within the current long exposure region by comparing PX with Xstart and Xstop and comparing PY with Ystart and Ystop. If PX has a value between the values of Xstart and Xstop, and PY has a value between the values of Ystart and Ystop, then the current pixel is within the current long exposure region and the procedure flows to operation 272. Otherwise, the current pixel is not located within the current long exposure region and the procedure flows to operation 268.

In operation 268, it is determined whether there are any more long exposure regions. If there are more long exposure regions, then the procedure returns to operation 264 to read the coordinates of the next long exposure region. As indicated by operation 270, if there are no more long exposure regions then the procedure continues with operation 240 in FIG. 6, wherein the current image data stored in the frame buffer if the current image is the short exposure image, or else discarded.

If the current image data is within a long exposure region, the procedure flows from operation 266 to operation 272 wherein it is determined whether the long exposure region is active. If the device only supports a single long exposure region, this operation is skipped and the procedure flows directly to operation 246 in FIG. 6, as indicated by operation 274. In one embodiment having multiple long exposure regions, the exposure length, which is expressed as a number of frames, is compared with the absolute value of the difference between the current frame and the short exposure frame. Thus, if the short exposure frame is either at the beginning of the exposure length or the end, then each long exposure region has an exposure period that includes the short exposure frame. In one embodiment, long exposure regions are permitted to overlap. Thus, if, in operation 272 it is determined that the current long exposure region is not active, then the procedure flows to operation 268 to check for additional long exposure regions. In another embodiment, registers 162 (FIG. 4) are programmed so that the exposure regions are sorted with the exposure region having the longest exposure period is listed first. In this case, the procedure can flow directly from operation 272 to operation 270 since any additional long exposure regions will be shorter and therefore also not be active. If the current pixel is determined to be within an active long exposure region then the procedure continues with operation 246 in FIG. 6, as indicated by operation 274.

It will be recognized by those skilled in the art that the procedures described above with reference to FIGS. 5 through 7 are performed in hardware using logic gates, and therefore not necessarily sequentially as might be suggested by the flowcharts. Thus, many operations may be performed in parallel and/or in a different order than presented above. Furthermore, there may be instances where a particular operation is combined with other operations such that no intermediary state is provided. Likewise various operations may be split into multiple steps with one or more intermediary states. Graphics controller 106 (FIGS. 1, 3, and 4) and other hardware devices incorporate logic typically designed using a hardware description language (HDL) or other means known to those skilled in the art of integrated circuit design. The generated circuits will include numerous logic gates and connectors to perform various operations and does not rely on software instructions. It is also possible to implement the procedures described above in software for execution on a processing device.

With the above embodiments in mind, it should be understood that the invention can employ various computer-implemented operations involving data stored in computer systems. These operations are those requiring physical manipulation of physical quantities. Usually, though not necessarily, these quantities take the form of electrical or magnetic signals capable of being stored, transferred, combined, compared and otherwise manipulated. Further, the manipulations performed are often referred to in terms such as producing, identifying, determining, or comparing.

Any of the operations described herein that form part of the invention are useful machine operations. The invention also relates to a device or an apparatus for performing these operations. The apparatus can be specially constructed for the required purpose, or the apparatus can be a general-purpose computer selectively activated or configured by a computer program stored in the computer. In particular, various general-purpose machines can be used with computer programs written in accordance with the teachings herein, or it may be more convenient to construct a more specialized apparatus to perform the required operations.

The invention can also be embodied as computer readable code on a computer readable medium. The computer readable medium is any data storage device that can store data, which can be thereafter be read by a computer system. The computer readable medium also includes an electromagnetic carrier wave in which the computer code is embodied. Examples of the computer readable medium include hard drives, network attached storage (NAS), read-only memory, random-access memory, CD-ROMs, CD-Rs, CD-RWs, magnetic tapes and other optical and non-optical data storage devices. The computer readable medium can also be distributed over a network-coupled computer system so that the computer readable code is stored and executed in a distributed fashion.

Although the foregoing invention has been described in some detail for purposes of clarity of understanding, it will be apparent that certain changes and modifications may be practiced within the scope of the appended claims. Accordingly, the present embodiments are to be considered as illustrative and not restrictive, and the invention is not to be limited to the details given herein, but may be modified within the scope and equivalents of the appended claims.

1. A method for generating a long exposure image, the method comprising:
receiving image data for a plurality of images;
for each of the images, adding image data corresponding to a long exposure region to a frame buffer, the adding comprising adding a color value for each pixel from the image data to a corresponding color value of a corresponding pixel stored in the frame buffer, and storing the sum in the frame buffer.

2. The method of claim 1, wherein the image data is encoded in an RGB format, the RGB format comprising, for each pixel, a red intensity value, a green intensity value, and a blue intensity value, the adding comprising adding a red, green, and blue intensity value for each pixel of image data corresponding to the long exposure region to respective red, green, and blue intensity values for a corresponding pixel in the frame buffer.

3. The method of claim 1, wherein the long exposure region extends over an entire area of each of the images.

4. The method of claim 1, wherein the long exposure region covers a portion of an area of each of the images, the method further comprising:
writing short exposure image data corresponding to a short exposure region when a selected one of the images is received, the short exposure region comprising a region outside the long exposure region.

5. The method of claim 1, further comprising:
for less than all of the images, adding image data corresponding to a second long exposure region to the frame buffer.

6. The method of claim 1, wherein the adding further comprises:
receiving data corresponding to a pixel of one of the images;
identifying whether the pixel lies within the long exposure region;
adding the data to corresponding data in the frame buffer and writing a resulting sum to the frame buffer when the pixel lies within the long exposure region;
writing the data to the frame buffer when data lies outside the long exposure region and the data corresponds to a short exposure frame; and
discarding the data when the data is outside the long exposure region and the data does not correspond to a short exposure frame.

7. The method of claim 1, wherein the adding further comprises:
receiving data corresponding to a pixel of one of the images;
identifying whether the pixel lies within an active long exposure region, the active long exposure region being one of the long exposure region and additional long exposure regions that has an exposure period that includes a current frame;
adding the data to corresponding data in the frame buffer and writing a resulting sum to the frame buffer when the pixel lies within the long exposure region;
writing the data to the frame buffer when data lies outside the long exposure region and the data corresponds to a short exposure frame; and
discarding the data when the data is outside the long exposure region and the data does not correspond to a short exposure frame.

8. A device for generating a long exposure image, the device comprising:
a camera interface for receiving image data for a plurality of images;
a frame buffer for temporarily storing data corresponding to an image;
a plurality of registers for storing operational parameters, the operational parameters including a definition for a long exposure region and an exposure period for the long exposure region; and
a long exposure logic in communication with the camera interface, the frame buffer, and the registers, the long exposure logic being configured to add image data corresponding to the long exposure region to the frame buffer for each of a plurality of images making up the exposure period, wherein the image data is added by adding a color value for each pixel of the long exposure region from the image data to a corresponding color value of a corresponding pixel stored in the frame buffer, and storing the sum in the frame buffer.

9. The device of claim 8, wherein the image data is encoded in an RGB format, the RGB format comprising, for each pixel, a red intensity value, a green intensity value, and a blue intensity value, the image data being added by adding a red, green, and blue intensity value for each pixel of image data corresponding to the long exposure region to respective red, green, and blue intensity values for a corresponding pixel in the frame buffer.

10. The device of claim 8, wherein the long exposure region extends over an entire area of each of the images.

11. The device of claim 8, wherein the long exposure region covers a portion of an area of each of the images and the long exposure logic is configured to write image data corresponding to a short exposure region to the frame buffer when one of the images is received, the short exposure region comprising a region outside the long exposure region.

12. The device of claim 11, wherein a value in the registers identifies the one of the images for storing the image data corresponding to the short exposure region.

13. The device of claim 8, wherein the long exposure logic is further configured to add, for fewer than all the images, image data corresponding to a second long exposure region to the frame buffer.

14. The device of claim 8, wherein the adding of the image data by the long exposure logic further comprises:
receiving data corresponding to a pixel of a current frame of the images;
identifying whether the pixel lies within the long exposure region;
adding the data to corresponding data in the frame buffer and writing a resulting sum to the frame buffer when the pixel lies within the long exposure region;
writing the data to the frame buffer when data lies outside the long exposure region and the current frame is a short exposure frame, the short exposure frame being a selected one of the images; and
discarding the data when the data is outside the long exposure region and the data does not correspond to the short exposure frame.

15. The device of claim 8, wherein the adding of the image data by the long exposure logic further comprises:
receiving data corresponding to a pixel of a current frame of the images;
identifying whether the pixel lies within an active long exposure region, the active long exposure region being one of the long exposure region and at least one additional long exposure region that has an exposure period that includes the current frame;
adding the data to corresponding data in the frame buffer and writing a resulting sum to the frame buffer when the pixel lies within the long exposure region;
writing the data to the frame buffer when data lies outside the long exposure region and the data corresponds to a short exposure frame; and
discarding the data when the data is outside the long exposure region and the data does not correspond to the short exposure frame.

16. A method for combining a plurality of frames of images in a video stream to a single long exposure image, the method comprising:
receiving image data corresponding to a pixel of a current one of the frames;
identifying whether the pixel corresponds to an active long exposure region, the active long exposure region being a long exposure region for which data from the current frame is to be stored;
adding the image data to stored image data when the pixel corresponds to the active long exposure region, the adding comprising arithmetically adding a luminance of the pixel corresponding to the image data to a luminance of a pixel defined by the stored image data and writing a sum resulting from the adding to a storage location;
writing the image data to the storage location when the pixel does not correspond to any active long exposure region and the current frame is a short exposure frame; and
discarding the image data when the pixel does not correspond to any active long exposure region and the current frame is not the short exposure frame.

17. The method of claim 16 wherein the short exposure frame is a selected one of the frames based on user interaction.

18. The method of claim 16 wherein the identifying comprises:
determining if the pixel is within a particular long exposure region by comparing coordinates of the pixel to coordinates of a pair of coordinates identifying opposite corners of the particular long exposure region.

19. The method of claim 18 wherein the identifying further comprises:
determining if the particular long exposure region is active by comparing an exposure period for the particular long exposure period with a difference between a current frame and a short exposure frame, the identifying comprising checking a next long exposure region when the pixel is outside the particular long exposure region or the particular long exposure region is not active.

20. The method of claim 16 wherein the identifying comprises:
determining if the long exposure region is active by comparing an exposure period for the long exposure period with a difference between a current frame and a short exposure frame.
